(19) United States
(12) Patent Application Publication
(10) Pub. No.: US 2023/0374679 A1
(43) Pub. Date: Nov. 23, 2023

(54) CATALYST-COATED MEMBRANE AND WATER ELECTROLYSIS CELL

(71) Applicant: Greenerity GmbH, Alzenau (DE)

(72) Inventors: Alessandro Ghielmi, Frankfurt am Main (DE); Dominik Gehrig, Hanau (DE); Jan Byrknes, Bad Vilbel (DE); Jens-Peter Suchsland, Alzenau (DE); Christian Eickes, Frankfurt am Main (DE)

(21) Appl. No.: 18/031,541

(22) PCT Filed: Oct. 7, 2021
(86) PCT No.: PCT/EP2021/077749

§ 371 Date: Apr. 12, 2023

(30) Foreign Application Priority Data
Oct. 13, 2020 (DE) 10 2020 126 797.5

(51) Int. Cl. C25B 11/081; C25B 11/067; C25B 11/054; C25B 9/23; C25B 1/04

(52) U.S. Cl. CPC C25B 11/081; C25B 11/067; C25B 11/054; C25B 9/23; C25B 1/04

(57) ABSTRACT

A catalyst-coated membrane includes a proton-exchange membrane, an anode applied to a first side of the membrane, including at least one noble-metal-containing catalyst, an areal weight of the noble-metal-containing catalyst, based on the noble metal content, being less than or equal to 0.6 mg/cm², and a cathode applied to a second side of the membrane, wherein an areal expansion of the catalyst-coated membrane is less than 20% after being held for two hours in water heated to 100° C.

### TECHNICAL FIELD

This disclosure relates to a catalyst-coated membrane having high power density at low catalyst loading and to a water electrolysis cell comprising the catalyst-coated membrane.

### BACKGROUND

Catalyst-coated membranes having a proton-exchange membrane coated on one side with an anode and on the opposite side with a cathode are known by the term CCM (catalyst coated membrane). When the CCM is used in water electrolysis, the term PEM-WE (proton-exchange membrane water electrolysis) is customary.

Proton-exchange membranes for use in PEM-WE are usually extruded polymer membranes based on perfluorosulfonic acid (PFSA). The most established examples of PEM are Nafion® N115 and Nafion® N117 from Chemours. Relatively thin, cast membranes, i.e., membranes printed by a solvent such as Nafion® NR212 continue to be used in the current literature.

In the anode electrode layer (anode for short), a catalyst is used to oxidize water (water splitting). This catalyst is often referred to as an OER (oxygen-evolution reaction) catalyst. OER catalysts are usually based on noble metals and contain noble metal oxides that exhibit high catalytic activity for water splitting. In addition, a proton-conducting polymer, what is known as an ionomer of the PFSA type, is usually used in the anode as a binder that is present as a mixture with the OER catalyst.

In the cathode electrode layer (cathode for short) a catalyst is used to reduce protons to hydrogen. (hydrogen-evolution reaction=HER catalyst). These catalysts are usually based on platinum, the platinum preferably being present in finely dispersed form on carbon powders. In addition, the cathode also usually includes a PFSA-based ionomer as a binder.

CCMs for PEM-WE uses are currently produced with high contents of the noble metals iridium and/or ruthenium, a typical areal weight, also referred to as (noble metal) loading, being 1 to 2 mg/cm², which ensures a sufficient OER rate. The areal weight (mg) refers here to the mass of the catalyst metal and the area (cm²) to the geometric area of the CCM on which the catalyst is present. This area is also referred to as the active area. A high areal weight, as indicated above, has hitherto been necessary to prevent losses in efficiency. Studies such as M. Bernt et al., The Electrochemical Society, 165 (5) F305-F314 (2018) have shown that these losses are particularly pronounced at an iridium loading of less than 0.4 mg/cm². The above publication suggests addressing this problem by producing thicker electrodes, but does not teach how to produce thicker electrodes without increasing the iridium loading at the same time.

It could therefore be helpful to provide a catalyst-coated membrane that, at a low anode noble metal loading, has good efficiency with the characteristic feature of a low voltage at a given current density, and a water electrolysis cell that also has the characteristic feature of good efficiency and thus also low operating costs as a consequence of reduced power consumption.

### SUMMARY

We provide a catalyst-coated membrane including a proton-exchange membrane, an anode applied to a first side of the membrane, including at least one noble-metal-containing catalyst, an areal weight of the noble-metal-containing catalyst, based on the noble metal content, being less than or equal to 0.6 mg/cm², and a cathode applied to a second side of the membrane, wherein an areal expansion of the catalyst-coated membrane is less than 20% after being held for two hours in water heated to 100° C.

### BRIEF DESCRIPTION OF THE DRAWINGS

FIG. 1 shows the cell voltage at a current density of 3.0 A/cm² as a function of the anode catalyst loading at a cell temperature of 80° C. for Example 1 and Comparative Example 1.

FIG. 2 shows the cell voltage at a current density of 1.2 A/cm² as a function of the anode catalyst loading at a cell temperature of 80° C. for Example 1 and Comparative Example 1.

FIG. 3 shows the cell voltage at a current density of 0.05 A/cm² as a function of the anode catalyst loading at a cell temperature of 80° C. for Example 1 and Comparative Example 1.

FIG. 4 shows the cell voltage at a current density of 3.0 A/cm² as a function of the anode catalyst loading at a cell temperature of 65° C. for Example 1 and Comparative Example 1.

### DETAILED DESCRIPTION

Our catalyst-coated membrane comprises a proton-exchange membrane (membrane for short), an anode applied to a first side of the membrane, and a cathode applied to a second side of the membrane. The anode has the characteristic feature of a low loading of catalyst and comprises for this purpose at least one noble-metal-containing catalyst, the areal weight of the noble-metal-containing catalyst, based on the noble metal content in the noble-metal-containing catalyst, being less than or equal to 0.6 mg/cm². As explained below, this low loading of noble-metal-containing catalyst in the catalyst-coated membrane is sufficient to achieve a low voltage, and thus high efficiency, at a given current density.

A low loading of this kind is made possible by the fact that an areal expansion of the catalyst-coated membrane is less than 20% after being held for two hours in water heated to 100° C. at an air pressure of 1013 hPa. In other words, this means that the catalyst-coated membrane has high dimensional stability. The high dimensional stability of the catalyst-coated membrane is substantially due to the high dimensional stability of the proton-exchange membrane used since the catalyst layers to be provided are generally not subject to any appreciable change in dimensions when used as intended (even when held for two hours in water heated to 100° C. at an air pressure of 1013 hPa). In other words, this means that if the membrane has an areal expansion of less than 20% after being held for two hours in water heated to 100° C. at an air pressure of 1013 hPa, a catalyst-coated membrane produced using this membrane will likewise have a corresponding areal expansion of less than 20% (after conditioning at 21° C. and 50% relative humidity, which corresponds to a baseline value for the dimensions of the catalyst-coated membrane under ambient conditions). Given that the dimensional stability of the catalyst-coated membrane as a whole is what is key, the areal expansion refers to the areal expansion of the catalyst-coated membrane. The dimensional stability and thus the areal expansion of the catalyst-coated membrane is described explicitly in the experimental section hereinbelow, wherein a catalyst-coated membrane is in the context of measuring the areal expansion understood as meaning a membrane coated with a catalyst on one or both sides (depending on the production process).

The use of dimensionally stable membranes as defined above allows good efficiency to be achieved with a low anode loading of 0.6 mg/cm² or below such as 0.2 mg/cm² or even 0.1 mg/cm².

Without being bound to the theory, it is assumed that the high efficiency when combining dimensionally stable (catalyst-coated) membranes and anodes having a low noble metal loading is based on the fact that a dimensionally stable membrane ensures the integrity of the anode upon mounting the catalyst-coated membrane in the cell and during operation under wet conditions. By contrast, when a membrane having low dimensional stability, i.e., having an areal expansion of more than 20%, is used according to the process described herein, the membrane swells excessively under the wet operating conditions and the anode loses its integrity, increasing the electrode resistance, which in turn leads to a reduction in efficiency, especially at high current densities. This loss of electrode integrity is almost nonexistent at high noble metal loadings since adequate anode connectivity is maintained, but at loadings below 0.6 mg/cm² the loss becomes significant and unacceptable.

On the other hand, in a dimensionally stable catalyst-coated membrane the anode integrity is maintained even at very low noble metal loadings. This can additionally be demonstrated by the fact that at low current densities, at which the efficiency is determined by the catalyst activity (and not by the resistance), very similar cell voltage values are obtained for both membrane types (dimensionally stable and non-dimensionally stable) across the entire loading range. Furthermore, the trend in cell voltage corresponds to the theoretically expected cell voltage trend. Conversely, membranes having high dimensional stability, and thus also catalyst-coated membranes having high dimensional stability, have at high current densities, for example, >1 A/cm², at which the resistance becomes significant, clear advantages once the anode noble metal loading becomes low.

The terms “loading,” “noble metal loading” or “areal weight” refer exclusively to the noble metal present in the catalyst used. The use of loading based on the noble metal is advantageous since, in noble metals, the metal accounts for a particularly high proportion of the cost of the catalyst.

In addition, the dimensional stability of the membrane and thus of the catalyst-coated membrane is understood as meaning the dimensional stability during the transition from the dry state to the wet state. The expansion that occurs here in the membrane and thus also in the catalyst-coated membrane describes the areal expansion that results from the expansion in two directions perpendicular to one another. Directions perpendicular to one another are understood here as meaning directions of expansion in the same plane and not the expansion of the catalyst-coated membrane in the direction of the layer thickness or arrangement of layers. More particularly, mutually perpendicular directions are understood as meaning the direction of expansion in the machine direction (MD) and in the transverse direction (TD), also referred to as the cross-machine direction, where the change in area can be expressed as a percentage areal expansion. High dimensional stability always means a low areal expansion of less than 20%.

By way of example, in a membrane having a length when dry of 100 mm (MD) and a width when dry of 100 mm (TD) and in which the length and width increases to 115 mm (MD) and 125 mm (TD) after soaking for two hours in water heated to 100° C. at an air pressure of 1013 hPa, the areal expansion is 43.75%, as explained in more detail below.

Membranes, and consequently also catalyst-coated membranes, having high dimensional stability, and thus having an areal expansion of less than 20% after being held for two hours in water heated to 100° C. at an air pressure of 1013 hPa, can be obtained in various ways and there is no specific restriction on the process by which they are produced.

According to a first example, one or more reinforcing structures are incorporated into a proton-exchange membrane with the result that the reinforcing structure(s) limit(s) the expansion of the membrane. The reinforcing structure can be introduced, for example, during the process of producing the membrane from an ionomer dispersion or ionomer solution. In this example, a previously formed reinforcing structure such as (bi)axially stretched PTFE (ePTFE, expanded PTFE), is impregnated with an ionomer dispersion and then dried so that the pores of the reinforcing structure are filled with ionomer. The membrane can subsequently be heated in a high-temperature step, for example, at about 150° C. to 200° C., to improve the stability of the membrane.

The ionomers used are preferably PF SA ionomers.

Reinforced membranes can also be obtained by lamination, for example, in a pressing or calendering process, of one or more non-reinforced membranes having a reinforcing structure. Membranes having a plurality of reinforcing structures can be obtained, for example, by lamination (for example, in a pressing or calendering process) of two or more membranes, of which at least two membranes have a reinforcing structure. This makes it possible to obtain membranes that have two or more reinforcing structures and very high dimensional stability, i.e., an areal expansion of less than 10% when the membrane is held in water heated to 100° C. at an air pressure of 1013 hPa for 2 hours.

Suitable reinforcing structures are, for example, woven or non-woven polymer structures, porous ceramic thin films, perforated polymer films or perforated inorganic films or (bi)axially stretched porous polymer films. Preferred reinforcing structures are also porous thin films of expanded polytetrafluoroethylene (ePTFE) or polyolefin, which permit the production of thin, yet strong, membranes having excellent electrochemical performance.

According to a second example, dimensionally stable membranes can be obtained by increasing the equivalent weight (EW) of the ionomer, thereby limiting the absorption of water by the membrane. The EW here indicates the mass of polymer per mole of ionic functional groups present in the ionomer. Depending on the type of ionomer used, those skilled in the art can determine the appropriate minimum equivalent weight at which the desired areal expansion, for example, less than 20%, is not exceeded. Non-reinforced membranes comprising ionomers having such an equivalent weight can be produced, for example, by extrusion or solvent-based coating processes.

The above processes, i.e., the introduction of one or more reinforcing structures and increasing the equivalent weight, can an in addition be combined.

Preference may in principle be given to the process by which one or more reinforcing structures are introduced into the membrane, since it is possible to obtain thin membranes, for example, ones having a layer thickness in the region of 50 μm, having very good dimensional stability, good mechanical properties, and low ionic resistance, which is particularly advantageous for water electrolysis cells.

The ionomers used in the polymer electrolyte membrane and in the catalyst layers are not specifically restricted and may be perfluorinated ionomers (PFSA), partially fluorinated or hydrocarbon-based (non-fluorinated) ionomers, it being possible to use different ionomers in the different layers of the catalyst-coated membrane.

The membrane may also be made up of sub-layers that can include different ionomers. Examples of ionomers of the PFSA type are Nafion® from Chemours, Aquivion® from Solvay Specialty Polymers, ionomers from 3M, Aciplex® from Asahi Kasei or Flemion® from Asahi Glass. Examples of hydrocarbon-based ionomers are sulfonated polyether ketones (sPEK), sulfonated polyether ether ketones (sPEEK), sulfonated polyketone ketones (sPKK), sulfonated polysulfones (sPSU), and sulfonated polyether sulfones (sPES).

Advantageously, the areal expansion of the catalyst-coated membrane is less than 15% and in particular less than 10% after being held for two hours in water heated to 100° C. at an air pressure of 1013 hPa, as described hereinbelow. This allows the efficiency of the catalyst-coated membrane to be improved and a particularly low voltage to be achieved for a given current density.

To further reduce the costs for the catalyst-coated membrane while maintaining high efficiency, the areal weight of the noble-metal-containing catalyst, based on the noble metal content, is preferably less than or equal to 0.4 mg/cm² and in particular less than or equal to 0.35 mg/cm².

It is advantageous that the catalytic performance of the catalyst-coated membrane while at the same time keeping financial outlay to a minimum when the areal weight of the noble-metal-containing catalyst, based on the noble metal content, is preferably greater than or equal to 0.02 mg/cm² and in particular greater than or equal to 0.05 mg/cm².

On account of the very good OER activity, the noble metal of the at least one noble-metal-containing catalyst is selected more particularly from iridium and ruthenium. This means that both iridium and ruthenium may be used individually as noble-metal-containing catalysts, or else in combination.

It is particularly advantageous in the context of high catalyst stability alongside outstanding OER activity when the noble-metal-containing catalyst is selected from iridium oxide, ruthenium oxide, mixtures thereof, and alloys thereof. Other elements may be added to improve the activity and/or stability of the OER catalyst. Any alloying metals may be selected in particular from tin (Sn), niobium (Nb), nickel (Ni), tantalum (Ta), titanium (Ti), cobalt (Co), zinc (Zn), platinum (Pt), iron (Fe), silicon (Si), and cerium (Ce), the alloying metals being present in the alloy in a content of less than 50% by weight.

Iridium and ruthenium oxide may be present, for example, in the form of (nano)partides or as thin films coated on substrates. In (nano)particles, the catalyst oxides may be free-standing, agglomerated or finely dispersed on a substrate, typically powders having a high specific surface area such as titanium oxide. When the catalysts are present in the form of thin films, it is possible to use as the substrate either inorganic, for example, ceramic, or organic compounds, for example, polyaromatic molecules such as perylenes.

The OER catalyst oxides can be obtained by wet-chemical methods, for example, precipitation of hydroxides starting from soluble salts with subsequent thermal treatment in air, or by thermal, dry processes (for example, “Adam's fusion method”) or by gas-phase processes. Various methods for the synthesis of iridium oxide are summarized by way of example in J. Hansaem and L. Jaeyoung (Journal of Energy Chemistry, vol. 46, July 2020, pp. 152-172.

To further improve the efficiency of the noble-metal-containing catalyst at low loading alongside high anode conductivity, the noble-metal-containing catalyst is preferably supported on inorganic and/or ceramic supports, especially on titanium oxide and/or niobium oxide and/or antimony-doped niobium oxide and/or tin oxide and/or antimony-doped tin oxide.

Further advantageously, the cathode comprises a platinum-containing and/or palladium-containing cathode catalyst, the platinum-containing and/or palladium-containing cathode catalyst being present more particularly on a carbon-containing support material. This is advantageous since platinum-containing and/or palladium-containing cathode catalysts have particularly high HER activity, which contributes to the power density of the catalyst-coated membrane. The dimensional stability of the catalyst-coated membrane is essentially unaffected by the provision of the cathode, consequently, for a catalyst-coated membrane having an anode and cathode the areal expansion of the catalyst-coated membrane is less than 20% after being held for two hours in water heated to 100° C. at an air pressure of 1013 hPa.

It is further advantageous when the proton-exchange membrane has a layer thickness of from 5 to 120 μm, more particularly from 15 to 90 μm, and more particularly from 35 to 75 μm. This achieves an advantageous balance between efficiency and dimensional stability.

It is also possible to use membranes of greater thickness, for example, up to 200 μm, although the high membrane proton resistance means this results in a significant reduction in efficiency, especially at high current densities. When using membranes in the lower thickness range, i.e., of about 50 μm and less, a hydrocarbon-based ionomer is preferably included in at least a sublayer of the membrane to reduce gas permeability from one side of the catalyst-coated membrane to the other side of the catalyst-coated membrane. Hydrocarbon-based ionomers have intrinsically lower gas permeability than PFSA ionomers. The crossing-over of hydrogen in particular should be minimized to prevent the formation of explosive mixtures on the anode side and/or the loss of current efficiency. Moreover, in the lower thickness range the use of reinforced membranes is preferable to improve the mechanical properties and long-term stability—many thousands of operating hours.

It is further advantageous when the proton-exchange membrane comprises at least one recombination catalyst, including in particular platinum particles. The platinum particles are preferably finely dispersed within the membrane. The recombination catalyst catalyzes the reaction of hydrogen crossing over from the cathode to the anode with oxygen from the anode side to prevent the formation of explosive mixtures on the anode side of a cell.

Anodes and cathodes of the catalyst-coated membrane may be produced by conventional methods. This may be done, for example, by dispersing a pulverulent noble-metal-containing catalyst together with an ionomeric binder in an organic solvent or in a mixture of water and one or more organic solvents. This dispersion is then stirred, optionally in a high-energy mixer, to allow good dispersion and to reduce the size of catalyst aggregates. Using a coating or printing device, the ink or paste thus obtained is then coated or printed directly onto the membrane surface (the first or second side of the proton-exchange membrane) or initially onto an inert substrate known as a decal. The coating or printing device employed may be, for example, a doctor blade, a slit nozzle, a coating roller, or a screen-printing or gravure-printing process. The liquid medium is then evaporated, affording a thin electrode layer. When one or both electrodes are coated onto an inert substrate, the dried electrode is then transferred onto the membrane surface by the application of heat and pressure, i.e., by what is known as a decal transfer method.

Alternatively, the ink or paste for producing the cathode can also be coated or printed directly onto a porous transport layer, especially a gas-diffusion layer. In this example, the term gas-diffusion electrode (GDE) is used. The anode is applied onto the membrane via a decal process or via direct membrane coating, resulting in a one-sided catalyst-coated membrane or what is known as a half-CCM. The membrane that is catalyst-coated (on both sides) is subsequently obtained upon mounting in the electrolysis cell, wherein a connection between the cathode catalyst layer and the membrane is obtained under the operating conditions of the cell.

We also provide a water electrolysis cell comprising a catalyst-coated membrane as disclosed above. The use of the catalyst-coated membrane gives the water electrolysis cell the characteristic feature also of high power density and high efficiency at relatively low production costs.

### EXAMPLES

### Methods

### Determination of the Dimensional Stability (Areal Expansion) of Membranes/Catalyst-Coated Membranes (CCMs for Short) During Water Absorption

A membrane or a membrane coated with catalyst on one or both sides (semi-CCM or CCM) was conditioned at 21° C. and 50% relative humidity until the size/dimensions did not change any further. A square with an edge length (L) of 80 mm×80 mm was then precisely cut out, for example, using a cutting die (L_{dry}=80 mm). The two edges were aligned along the machine direction and cross-machine direction respectively. The direction was marked with a permanent marker. The square piece (membrane, half-CCM or CCM) was then held in water heated to 100° C. at an air pressure of 1013 hPa for 2 h. The piece was then removed from the water, excess water droplets quickly dabbed off, and the edge lengths of the square were measured with calipers with a resolution of 0.01 mm, resulting in the edge lengths L_{1,wet} and L_{2,wet}.

The change in area (%) was calculated according to formula (1):

100×[(L_{1,wet}×L_{2,wet})−L_{dry}²]/L_{dry}² (1).

The measurement of the swelling behavior, and thus the areal expansion of the membrane, half-CCM or CCM, at 100° C. (this corresponds to the temperature of water heated to 100° C. at an air pressure of 1013 hPa at an air pressure of 1013 hPa) is a known established condition and also correlates to the swelling behavior of the membrane and thus with the swelling behavior of the half-CCM or CCM in water under other conditions too, for example, at room temperature and especially in hot water, which is the normal operating condition of the membrane, half-CCM or CCM. In other words, membranes/semi-CCMs/CCMs with greater swelling behavior at 100° C. and thus high areal expansion also show greater swelling behavior at lower temperatures. However, measuring the swelling behavior at 100° C. offers the advantage that this temperature is closely controlled by the boiling point of the water and is therefore applied.

### Power/Efficiency in the Water Electrolysis Cell

The efficiency of the CCM was measured in a single cell having an active area of 25 cm². The cell consisted of platinized titanium plates having a column bar flow field design on the anode side and the cathode side. The flow field plate on the cathode side was additionally gold-plated. A titanium sinter (1 mm thickness) and carbon paper (Toray Industries TGP-H-120) were used as the porous transport layer and gas diffusion layer on the anode side and on the cathode side. The cell was closed with six M8 screws with a torque of 10 Nm. Deionized water having a conductivity of less than 1 μS/cm was circulated on the anode side. The cell was heated from room temperature to 60° C. over a 20-min period through heating pads placed on the end plates. The temperature was then increased to 80° C. over a 20-min period. The cell was conditioned by cycling ten times between 0 and 1 A/cm² with a hold time of 5 min for each step. At the end of the conditioning, the cell was held at 1 A/cm² for 10 min.

Current-voltage characteristics (polarization curves) were recorded at 80° C. and 65° C. by increasing the current density from low to high values (A/cm²), each time with a hold time of 10 min. The steps were specifically:
0.01-0.02-0.03-0.05-0.08-0.1-0.2-0.4-0.6-0.8-1.0-1.2-1.4-1.6-1.8-2.0-2.25-2.5-2.75-3.0 (each in A/cm²).

### Production of Anode Ink

20.00 g of a commercial iridium-based catalyst (Elyst Ir75 0480; Umicore, Germany, IrO₂ supported on TiO₂; 75% by weight of iridium) was mixed with 10.20 g of Nafion® D2020 ionomer dispersion (Chemours; USA) having an ionomer content of 20.2% by weight. 0.5 g of water and 69.30 g of 2-propanol were then added. The mixture was dispersed for 30 min by a bead mill using spherical zirconia beads having a diameter of 1 mm. The stirring disk had a diameter of 45 mm and was set to a speed of rotation of 2130 revolutions per minute. The quality of the dispersion was ensured by visually checking for the absence of catalyst aggregates. The dispersion quality was further confirmed by a good coating quality, i.e., no visible aggregates or streaking in the wet or dry layer.

### Production of Anodes Having Varying Iridium Loading on a Decal

Anode inks were coated onto a glass-fiber-reinforced PTFE substrate, in other words, a decal by a spiral applicator (wire bar). The wet film thickness was increased incrementally by selecting different spiral applicators having a progressively increasing wire thickness to give an iridium metal loading (areal weight) of 0.15 mg/cm², 0.25 mg/cm², 0.5 mg/cm², 1.0 mg/cm², and 2.25 mg/cm². The wet layer thickness was varied here between 10 μm and 285 μm by selecting spiral applicators having the appropriate wire diameters. After coating, the wet layers were dried in an oven at 110 C for 5 min. The actual iridium metal loading was determined gravimetrically by recording the exact decal weight before and after CCM lamination, as described in Example 1.

### Example 1: Production of Catalyst-Coated Membranes (CCMs) Having High Dimensional Stability (Low Areal Expansion) and Varying Anode Catalyst Loading

A membrane having high dimensional stability and a thickness of 41 μm, comprising two expanded PTFE (ePTFE) reinforcing structures, was obtained by laminating an unreinforced PFSA membrane having a thickness of 25 μm between two reinforced PFSA membranes each having a thickness of 8 μm. The membrane was laminated in a press at a temperature of 160° C. and a pressure of 1.5 MPa for 1 min. The machine directions of the three membranes were each aligned parallel to one another. The linear expansion of the membrane caused by absorption of water (100° C.) was measured according to the described method, affording values of 2.0% and 3.3%. The resulting areal expansion was 5.4%.

Five CCMs were produced using a membrane of this type in a press by a decal process. This was done by arranging the membranes between anode and cathode decals (5 cm×5 cm) and pressing them at a temperature of 180° C. and a pressure of 1.5 MPa for 1 min, thereby transferring the electrode layers from the decal substrate to the membranes.

The cathode was identical for all CCMs and consisted of a catalyst comprising platinum on a carbon support and a Nafion® ionomer binder. The ratio by weight of catalyst to ionomer in the cathode was 3:1 and the platinum loading was 0.3 mg/cm². The cathode was likewise applied to glass-fiber-reinforced PTFE.

In the production of the CCMs, the anode loading of the different CCMs was however varied by using anode decals having varying loadings, as described above in “Production of anodes having varying iridium loadings on a decal.” The actual anode loading was determined gravimetrically by determining the weight of the anode decal before transfer (anode electrode on PTFE substrate) and of the anode decal after transfer (pure PTFE substrate). The areal weight (loading) of the iridium was calculated by determining the difference (anode decal minus pure PTFE substrate) and including the known composition of the dry electrode layer. The following anode iridium loadings were obtained for the five CCMs: 0.162 mg/cm², 0.261 mg/cm², 0.474 mg/cm², 1.029 mg/cm², and 2.072 mg/cm².

In addition, the CCM having an anode iridium loading of 0.261 mg/cm² was investigated to measure the dimensional stability upon absorption of water (100° C., see method description). The CCM showed a change in dimensions of 1.6% in length and 3.0% in width. This corresponds to an areal expansion of 4.6%.

By using a membrane having high dimensional stability, the corresponding CCM too exhibited high dimensional stability.

The swelling behavior of the same CCM having an anode iridium loading of 0.261 mg/cm² was also investigated in a water bath at lower temperatures. At room temperature, the areal expansion was 3.9%, while at a temperature of 80° C. the areal expansion was 4.1%.

### Comparative Example 1: Production of a CCM as Per the Prior Art and with Varying Anode Iridium Loading

The CCM according to the prior art was produced in analogous manner to the procedure of Example 1, with the difference that the membrane used was Nafion® NR212 (Chemours, USA). This membrane, which has a thickness of approx. 50 μm, is an established membrane in PEM-WE publications.

The linear dimensional change of the NR212 membrane upon absorption of water (100° C.) was 20.0% and 19.7%. The resulting areal expansion was 43.6%.

The anodes and cathodes used corresponded to those from Example 1.

The following anode iridium loadings were obtained for the following likewise five CCMs: 0.155 mg/cm², 0.303 mg/cm², 0.504 mg/cm², 1.068 mg/cm², and 2.102 mg/cm².

Even though the same electrodes had been used as in Example 1, slightly different loadings were obtained compared to the CCMs from Example 1, owing to the occurrence of slight inhomogeneities in loading during coating on the decal substrate. However, the differences were minor enough to permit a comparison of the CCM series having high information value.

The CCM with NR212 having an anode iridium loading of 0.303 mg/cm² was additionally investigated to measure the dimensional stability upon absorption of water (100° C., see method description). The CCM showed a change in dimensions of 15.7% in length and 15.9% in width. This corresponds to an areal expansion of 34.1%.

By using a membrane having low dimensional stability, the corresponding CCM likewise exhibited low dimensional stability.

The swelling behavior of the same CCM having an anode iridium loading of 0.303 mg/cm² was also investigated in a water bath at lower temperatures. At room temperature, the areal expansion was 14.4%, while at a temperature of 80° C. the areal expansion was 26.6%.

As already described in the methods section, the swelling behavior in water heated to 100° C. at an air pressure of 1013 hPa correlates also with the swelling behavior at lower temperatures.

### Comparison of Power/Efficiency in Water Electrolysis Cells—CCMs from Example 1 and Comparative Example 1

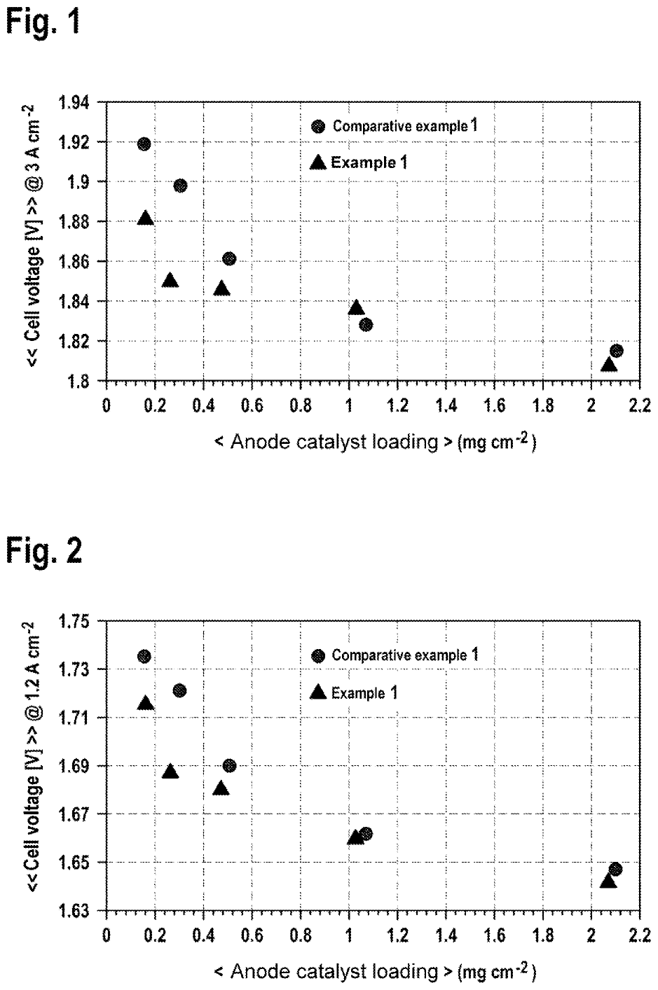

The CCMs from Example 1 and Comparative Example 1 were electrochemically characterized in a water electrolysis cell according to the method described above (“Power/efficiency in the water electrolysis cell”). The results, i.e., the cell voltage at a given current density as a function of the anode catalyst loading (anode noble metal loading), are shown in FIGS. 1 to 4. From the data it can be seen that, at the two temperatures investigated and at an anode catalyst loading of equal to or less than 0.6 mg/cm² and current densities above 1 A/cm², CCMs with high dimensional stability exhibit better efficiency than CCMs having a membrane with low dimensional stability. The current density of relevance for use is at higher current densities (>1 A/cm²) to produce a large amount of hydrogen per electrolyzer unit area and per unit time.

FIG. 1 shows the cell voltage of water electrolysis cells from Example 1 and Comparative Example 1 at a current density of 3.0 A/cm² and a cell temperature of 80° C. for various anode iridium loadings. A comparison between our CCM having a membrane with high dimensional stability and thus low areal expansion (triangles; Example 1) and a CCM having a membrane with low dimensional stability and thus high areal expansion (circles; Comparative Example 1) demonstrates clearly the advantage of using the dimensionally stable membrane at an anode loading below 0.6 mg/cm², the improvement in cell voltage being 40 mV and over.

FIG. 2 shows the cell voltage of water electrolysis cells from Example 1 and Comparative Example 1 at a current density of 1.2 A/cm² and a cell temperature of 80° C. for various anode iridium loadings. A comparison between our CCM having a membrane with high dimensional stability and thus low areal expansion (triangles; Example 1) and a CCM having a membrane with low dimensional stability and thus high areal expansion (circles; Comparative Example 1) demonstrates clearly the advantage of using the dimensionally stable membrane at an anode loading below 0.6 mg/cm².

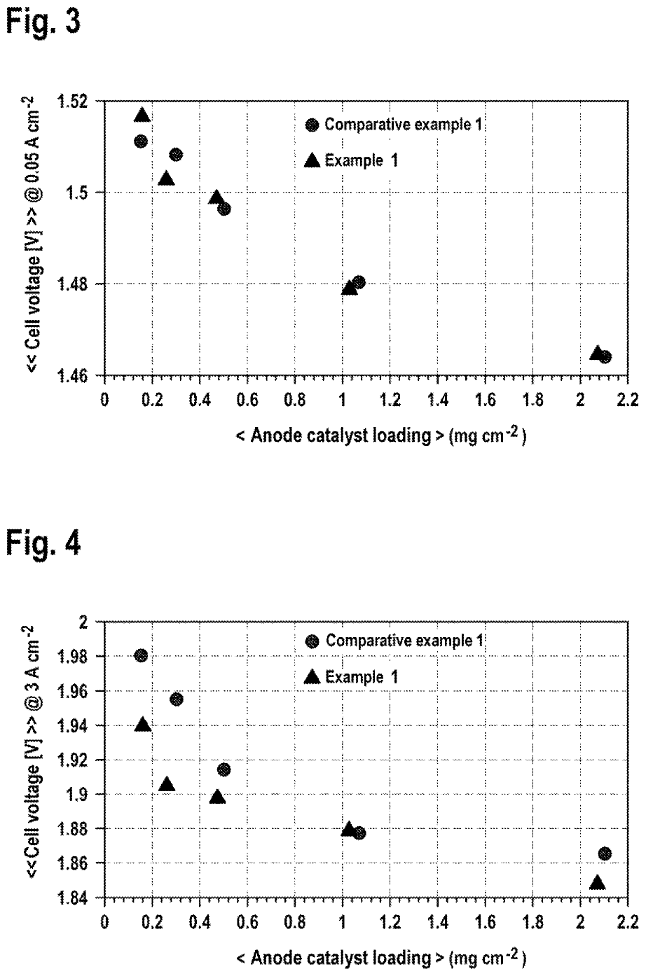

FIG. 3 shows the cell voltage of water electrolysis cells from Example 1 and Comparative Example 1 at a current density of 0.05 A/cm² and a cell temperature of 80° C. for various anode iridium loadings. The power/efficiency in the region of this low current density is for the two membrane types similar across the entire anode loading range. The voltage difference between loading at 2 mg/cm² and at 0.2 mg/cm² is 45 to 50 mV, which is equivalent to a slope of 45-50 mV/decade and thus corresponds to the theoretical expectation for an iridium oxide OER catalyst. The slope should strictly speaking be calculated on the basis of the resistance-corrected cell voltage, but the correction, which amounts to just a few mV, is negligible at such low current densities and, since the correction is disregarded for both loadings, the slope and hence the conclusions drawn therefrom are unchanged.

FIG. 4 shows the cell voltage of water electrolysis cells from Example 1 and Comparative Example 1 at a current density of 3.0 A/cm² and a cell temperature of 65° C. for various anode iridium loadings. A comparison between our CCM having a membrane with high dimensional stability and thus low areal expansion (triangles; Example 1) and a CCM having a membrane with low dimensional stability and thus high areal expansion (circles; Comparative Example 1) demonstrates clearly the advantage of using the dimensionally stable membrane at an anode loading below 0.6 mg/cm², the improvement in cell voltage being 40 mV and over.

In addition to the above written description, explicit reference is hereby made to the graphical representation in FIGS. 1 to 4 for the supplementary disclosure thereof.

1-10. (canceled)

11. A catalyst-coated membrane comprising:
a proton-exchange membrane,
an anode applied to a first side of the membrane, comprising at least one noble-metal-containing catalyst, an areal weight of the noble-metal-containing catalyst, based on the noble metal content, being less than or equal to 0.6 mg/cm², and
a cathode applied to a second side of the membrane, wherein an areal expansion of the catalyst-coated membrane is less than 20% after being held for two hours in water heated to 100° C.

12. The catalyst-coated membrane as claimed in claim 11, wherein an areal expansion of the catalyst-coated membrane is less than 15% after being held for two hours in water heated to 100° C.

13. The catalyst-coated membrane as claimed in claim 11, wherein the areal weight of the noble-metal-containing catalyst, based on the noble metal content, is less than or equal to 0.4 mg/cm².

14. The catalyst-coated membrane as claimed in claim 11, wherein the areal weight of the noble-metal-containing catalyst, based on the noble metal content, is greater than or equal to 0.02 mg/cm².

15. The catalyst-coated membrane as claimed in claim 11, wherein the noble metal is selected from iridium and ruthenium.

16. The catalyst-coated membrane as claimed in claim 11, wherein the noble-metal-containing catalyst is selected from iridium oxide, ruthenium oxide, mixtures thereof, and alloys thereof.

17. The catalyst-coated membrane as claimed in claim 11, wherein the noble-metal-containing catalyst is supported on inorganic and/or ceramic supports, titanium oxide and/or niobium oxide and/or antimony-doped niobium oxide and/or tin oxide and/or antimony-doped tin oxide.

18. The catalyst-coated membrane as claimed in claim 11, wherein the cathode comprises a platinum-containing and/or palladium-containing cathode catalyst, the platinum-containing and/or palladium-containing cathode catalyst being present on a carbon-containing support material.

19. The catalyst-coated membrane as claimed in claim 11, wherein the proton-exchange membrane has a layer thickness of 5 to 120 μm, and/or
the proton-exchange membrane comprises at least one recombination catalyst or platinum particles.

20. A water electrolysis cell comprising a catalyst-coated membrane as claimed in claim 11.
